(19) United States
(12) Patent Application Publication
(10) Pub. No.: US 2009/0140187 A1
(43) Pub. Date: Jun. 4, 2009

(54) Pressure control valve

(76) Inventors: Santos Burrola, Cd. Juarez (MX); Francisco Morales, Cd. Juarez (MX)

Correspondence Address: DELPHI TECHNOLOGIES, INC., M/C 480-410-202, PO BOX 5052, TROY, MI, 48007, US

(21) Appl. No.: 11/999,232

(22) Filed: Dec. 4, 2007

(51) Int. Cl. F16K 31/00

(52) U.S. Cl. 251/129.02

(57) ABSTRACT

A pressure control valve includes a valve body having an axial flow path, a valve seat integrated into the valve body, a retention cup positioned within the flow path, a spring received and guided by the flow passage, and an armature connected to the spring. The spring maintains the armature positioned in the retention cup keeping the flow path open. A solenoid moves the armature from the retention cup to the valve seat blocking the flow path. The pressure control valve may be used for controlling a high-pressure single-piston pump and has the capability for controlling pressure or flow with a commanded input electrical voltage or current, while simplifying the component design and reducing the amount of components and, thus, the complexity of the assembly process. The pressure control valve may be used, for example, to manage the fuel rail pressure of a gasoline direct injection internal combustion engine.

### TECHNICAL FIELD

The present invention relates to electromechanical actuators; more particularly, to pressure control valves for application in gasoline internal combustion engines; and most particularly, to a pressure control valve for application in a fuel system of a gasoline direct injection engine.

### BACKGROUND OF THE INVENTION

Electromechanical actuators for applications in internal combustion engines are well known, and are typically used to control the flow and/or pressure of the supplied fluid through one or several fluid passages. In some cases it is desired that the control pressure or flow output is proportional to an input electrical signal to the coil of the electromagnet. In most specialized cases, the valve design must be customized to the needs of a specific application, for example, for very fast on and off pressure cycling requirements in fuel delivery and control systems, such as gasoline direct injection (GDI) engines. Another typical requirement for valve applications in GDI engines includes tight tolerances for the consistency in the pressure response times.

For example, a high-pressure single-piston pump driven via a pulley or directly from one of the engine shafts manages the GDI fuel rail pressure control. The pressure pulsations of such a pump are controlled entirely or partially by a normally open on/off control valve that creates pumping and spilling flow conditions. Such valve is typically synchronized to the camshaft that will trigger the valve according to the angle of the cam and the required flow or pressure delivery to the fuel rail assembly and injectors.

Different control valves exist in the art to achieve different kinds of performances. Material selected for the control valve has to be corrosion resistant to different blends of fuel and typically the design configuration makes such pump an expensive component that increases the overall system cost considerably.

Pressure control valves for high-pressure pumps that are able to deliver fuel from a fuel tank to a fuel rail assembly at a high-pressure must manage the occurring magnetic, mechanical, and hydraulic forces adequately to produce the desired pressure or flow output. Factors such as friction, hydraulic stiction, component misalignment, under-over damping, inertia, or mass must be minimized in order to reduce actuator performance variation and to enhance part reliability.

What is needed in the art is a pressure control valve that significantly simplifies the component design and reduces the amount of components used thereby reducing the complexity and cost of the assembly process.

It is a principal object of the present invention to provide a pressure control valve for controlling a high-pressure single-piston pump that has a low mass armature geometry and an integral seat with in line flow configuration for improved flow behavior and that is designed to reduce the pump packaging.

### SUMMARY OF THE INVENTION

Briefly described, a pressure control valve for controlling a high-pressure single-piston or multiple-piston pump has the capability for controlling pressure or flow with a commanded input electrical voltage or current, while simplifying the component design and reducing the amount of components and, thus, the complexity of the assembly process. The pressure control valve in accordance with the invention may be used for, but is not limited to, applications in the automobile industry, for example, to manage the fuel rail pressure of a gasoline direct injection (GDI) internal combustion engine.

The pressure control valve in accordance with the invention includes a spring that biases the armature section to keep the valve normally open. The armature mechanical net load may be set in spring preload to prevent self-closure caused by reverse flow.

Utilization of a ball armature in accordance with the invention simplifies the valve design by reducing the number of components. The ball armature is self guided and, therefore, controls the occurring radial forces with tight clearances. The armature stroke may be determined by a retention cup positioned in line with the flow within the housing. Accordingly, a flow path that minimizes the force created by the back flow may be created making the design of the control valve robust for applications at different engine speeds. Consequently, the control valve in accordance with the present invention may have a fast response with low variation.

The magnetic ball armature is moved from an open position to a closed position by an electromagnetic field created with a solenoid. The coil of the solenoid is kept dry by positioning it outside of the valve body and by over molding the spool the coil is wound around with a plastic material. Using a dry coil design improves the body leakage performance and reduces hydrocarbon emissions typically carried by fuel vapors. Furthermore, the core of the solenoid is cooled by the flow of the fuel through the pressure control valve. Accordingly the pressure control valve in accordance with the invention has a self-cooling design.

Still further, the outlet port of the pressure control valve is designed to be received by the inlet port of a high-pressure single-piston pump, which may reduce the pump packaging and simplify the assembly process.

### BRIEF DESCRIPTION OF THE DRAWINGS

The present invention will now be described, by way of example, with reference to the accompanying drawings, in which:

FIG. 1 is a schematic diagram of a prior art fuel system of a gasoline direct injection engine in accordance with the invention; and

FIG. 2 is a cross-sectional view of a pressure control valve in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

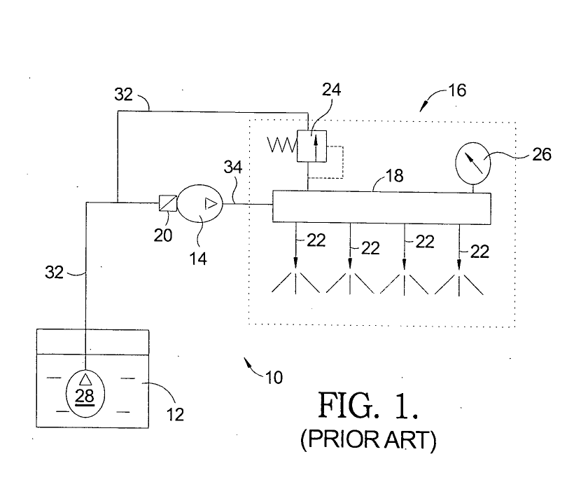

Referring to FIG. 1, a prior art fuel system 10 of a gasoline direct injection (GDI) engine includes a fuel tank 12, a pressure control valve 20, a high-pressure pump 14, and a fuel rail assembly 16. Fuel rail assembly 16 includes a fuel rail 18, a plurality of fuel injectors 22, a pressure limiting valve 24 and a high-pressure sensor 26 that monitors the pressure in fuel rail 18. Pressure limiting valve 24 allows fuel to return to fuel tank 12 in the case that the pressure in fuel rail 18 overcomes a preset pressure limit of valve 24. A low-pressure pump 28 is incorporated within fuel tank 12. A low-pressure line 32 connects low-pressure pump 28 with pressure control valve 20 and pressure limiting valve 24, while a high-pressure line 34 connects high-pressure pump 14 with fuel rail 18.

Fuel injectors 22 are adapted to receive fuel from fuel rail 18 and to deliver fuel directly into the combustion chamber of each cylinder (not shown). High-pressure pump 14 may be a single-piston reciprocating pump that has a piston (not shown) that draws fluid, in this case fuel, into a chamber when stroked in one direction and expels fluid from the chamber when stroked in the other direction. Thus, pump 14 delivers a single charge of fuel during each stroking cycle.

Fuel tank 12 stores the fuel required for operating the DIG engine. Low-pressure pump 28 delivers fuel with low pressure from tank 12 to high-pressure pump 14 via low-pressure line 32. High-pressure pump 14 delivers highly pressurized fuel to fuel rail 18 via high-pressure line 34. High-pressure fuel pump 14 is typically driven mechanically by the engine via a pulley or directly from one of the engine shafts.

Pressure control valve 20 is positioned between fuel pump 28 and high-pressure pump 14 and typically controls entirely or partially the pressure pulsations of high-pressure pump 14 and creates pumping and spilling flow conditions and, therefore, is operated as a fuel-metering device. Pressure control valve 20 controls flow and pressure of the fuel to fuel rail 18. Pressure control valve 20 is an on/off valve that is normally open allowing flow from fuel tank 12 to pump 14 and vice versa. Pressure control valve 20 may be controlled by an electric actuator, such as an electromagnet, and may continuously adjust the flow from low-pressure pump 28 to high-pressure pump 14. If pressure control valve 20 is operated in an open position, fuel flow from low-pressure pump 28 to high-pressure pump 14 or in inverse direction is enabled. If pressure control valve 20 is operated in a closed position, fuel flow from low-pressure pump 28 to high-pressure pump 14 is interrupted, high-pressure pump 14 pressurizes fuel previously suctioned in, and flow of the pressurized fuel to fuel rail 18 only is enabled. Pressure control valve 20 may enable pressurization of the fuel from about 4 to 6 bars at an outlet of low-pressure valve 28 to about 40 to 200 bars at an outlet of high-pressure pump 14.

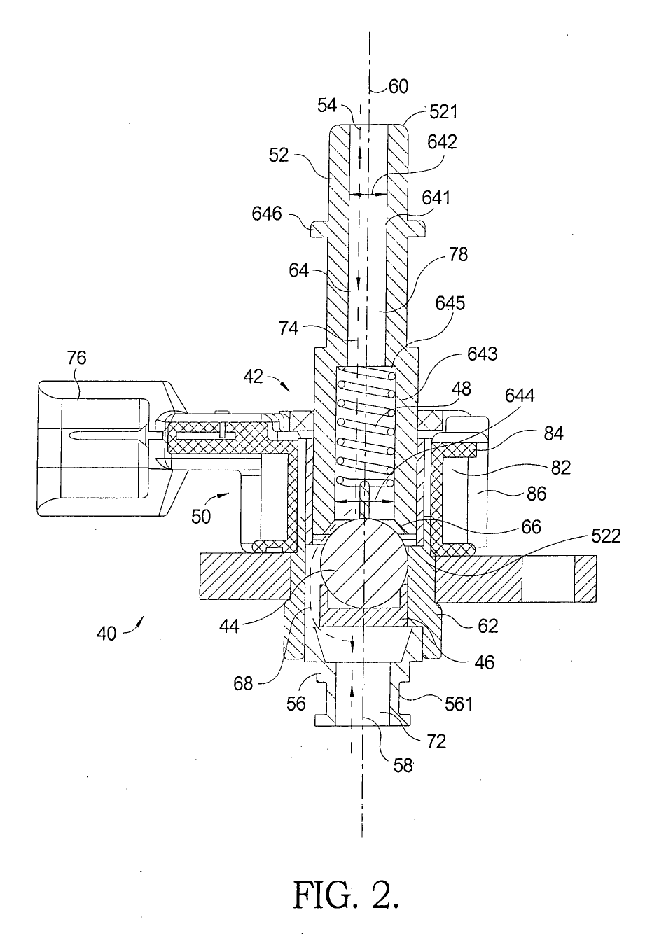

Referring to FIG. 2, a pressure control valve 40 in accordance with the invention includes a valve body 42, an armature, such as a magnetic ball 44, that is retained by a retention cup 46 and permanently connected to a spring 48, and a solenoid 50 positioned around valve body 42. Pressure control valve 40 extends axially along an axis 60. In a preferred embodiment, valve body 42 includes an inlet segment 52 forming an inlet port 54, an outlet segment 56 forming an outlet port 58, and a center segment 62 connecting inlet segment 52 with outlet segment 56. Inlet port 54 is in controlled fluid communication with a fuel tank through a low-pressure line, such as fuel tank 12 and low-pressure line 32 shown in FIG. 1. Outlet port 58 is in direct fluid communication with an inlet port of a high-pressure pump, such as high-pressure pump 14 shown in FIG. 1.

Inlet segment 52 has preferably a cylindrical shape and includes cylindrical center bore 64 that extends along axis 60. Cylindrical bore 64 includes a first section 641 positioned proximate to an upper end 521 and having a first diameter 642 and a second section 643 having a second diameter 644 that is larger than first diameter 642. Consequently, cylindrical bore 64 includes a shoulder 645 where first section 641 meets second section 643. Second section 643 receives and guides spring 48 and shoulder 645 is utilized to retain the position of spring 48 in an axial direction. At the outer circumference, inlet segment 52 may include connection features 646 that may enable preferably quick connection of inlet segment 52 to a low-pressure line of a fuel system, such as low-pressure line 32 of fuel system 10 shown in FIG. 1, for receiving fuel from a fuel tank, such a fuel tank 12 shown in FIG. 1. Connection features 646 are not limited to quick connection features but may be, for example, threads. A lower end 522 of inlet segment 52 is designed as a valve seat 66 and is preferably conically tapered. Valve seat 66 has a size adapted to the diameter of ball 44. This ensures that flow 74 through bore 64 can be completely stopped when ball 44 is positioned in valve seat 66. Integrating valve seat 66 in inlet segment 52 reduces the number of components compared to prior art pressure control valves.

Center segment 62 has preferably a cylindrical shape and includes a cylindrical center bore 68 that extends along axis 60. Bore 68 is designed to receive and retain inlet segment 52 and outlet segment 54. The size of bore 68 is adapted to the size of an outer circumference of inlet segment 52 and outlet segment 54 and to allow flow around ball 44. Retention cup 46 may be secured to the inner wall of center segment 62 that is formed by bore 68.

Outlet segment 56 has preferably a cylindrical shape and includes a cylindrical center bore 72 that extends along axis 60. An outer circumference of outlet segment 56 is preferably adapted to the size of an inlet port of a high-pressure pump, such as pump 14 shown in FIG. 1 and enables connection of pressure control valve 40 to a high-pressure pump, such as pump 14 shown in FIG. 1. The outer circumference of outlet segment 56 may include a groove 561 for receiving an o-ring. The axial length of outlet segment 56 that is inserted into a high-pressure pump may be shorter compared to prior art pressure control valves resulting in material and therefore manufacturing cost savings.

Center bore 64 of inlet segment 52, center bore 68 of center segment 62, and center bore 72 of outlet segment 56 are in fluid communication and, thus, form a centered axial flow path 78 of valve 40 that extends from inlet port 54 to outlet port 58. Flow 74 is possible in both directions from inlet port 54 to outlet port 58 and from outlet port 58 to inlet port 54 when ball 44 is positioned in retention cup 46 and, thus, when valve 40 is open. Flow 74 is stopped when ball 44 is positioned in valve seat 66 and, thus, when valve 40 is closed. The flow direction is determined by the movement of a piston in a high-pressure pump, such as pump 14 in FIG. 1. For example, during the downward stroke of the piston, flow 74 from inlet port 54 to outlet port 58 occurs, and during the upward stroke of the piston, flow 74 from outlet port 58 to inlet port 54 occurs. By positioning retention cup 46 and valve seat 66 in flow path 78, the forces on the ball 44 created during the upward stroke of the piston of the pump can be minimized.

Ball 44 is in a preferred embodiment movable by solenoid 50 from a first position in which ball 44 is positioned in retention cup 46 and a second position in which ball 44 is positioned in valve seat 66 and, therefore, from an open position to a closed position of valve 40. Spring 48 is preferably designed to normally maintain ball 44 positioned in retention cup 46 to keep valve 40 open even when the flow 74 from outlet port 58 to inlet port 46 occurs. Spring 48 maintains ball 44 in retention cup 46 and keeps valve 40 open until an electrical signal is sent. A current sent via an electrical connector 76 to solenoid 50 energizes valve 40 by creating a magnetic field that moves ball 44 from its position in retention cup 46 to valve seat 66, thereby blocking flow path 78 and stopping flow 74 towards inlet port 54 and, thus, closing valve 40. The force needed to move ball 44 into valve seat 66 may be lower compared to forces applied in prior art control pressure valves, since flow 74 towards inlet port 54 assists upward movement of ball 44 from retention cup 46 to valve seat 66. In a preferred embodiment, solenoid 50 is an electromagnet including a coil 82 wound around a spool 84. Spool 84 may be over molded with a plastic material 86 to protect coil 82 from the environment, for example, from corrosive fluids. By positioning solenoid 50 around the outer circumference of valve body 42, the core of solenoid 50 or coil 82 is cooled instantly by flow 74 passing through flow path 78.

Referring now to FIGS. 1 and 2, pressure control valve 40 is used, in the preferred embodiment, in a fuel system of a gasoline direct injection (GDI) engine, such as fuel system 10 illustrated in FIG. 1. Pressure control valve 40 may replace prior art pressure control valve 20 and may be integral with high-pressure pump 14. Pressure control valve 40 may be triggered by an electronic signal sent from an electronic control unit (not shown), which determines the time and duration of fuel injection by fuel injectors 22 in accordance with operating parameters of the engine, such as engine speed, load, temperature, etc. During an injection event, normally open pressure control valve 40 is closed by supplying a current to solenoid 50 and creating a magnetic field that moves ball 44 upwards from its position in retention cup 46 to valve seat 66 thereby blocking flow path 78 and stopping flow 74 towards inlet port 52. The upward stroke of the piston of high-pressure pump 14 compresses the previously suctioned in fuel and pressurized fuel flows through a discharge bore of pump 14 and then via high-pressure line 34 to fuel rail 18. Once the pump 14 is pressurized, the valve 40 can be de-energized and the high pressure could keep the valve 40 closed until the next charging event comes; this allows to reduce the power and heat on the valve. Between each injection event when pressure control valve 40 is open, an amount of fuel is drawn from fuel tank 12 through flow path 78 of pressure control valve 40 into an inlet port of high-pressure pump 14 during the downward stroke of the piston, and flows back into fuel tank 12 through flow path 78 during the upward stroke of the piston of pump 14.

While pressure control valve 40 has been described for application in a fuel system of a gasoline direct injection (GDI) engine other applications are possible.

While the invention has been described by reference to various specific embodiments, it should be understood that numerous changes may be made within the spirit and scope of the inventive concepts described. Accordingly, it is intended that the on not be limited to the described embodiments, but will have full scope defined language of the following claims.

What is claimed is:

1. A pressure control valve, comprising:
a valve body including a centered axial flow path;
a valve seat associated with said valve body;
a retention cup positioned within said flow path;
a spring received and guided by said flow path;
an armature connected to said spring, wherein said spring maintains said armature positioned in said retention cup keeping said flow path open; and
a solenoid positioned around an outer circumference of said valve body, said solenoid moving said armature from said retention cup to said valve seat blocking said flow path.

2. The pressure control valve in accordance with claim 1, further including an inlet port formed by said valve body.

3. The pressure control valve in accordance with claim 2, wherein said inlet port is in controlled fluid communication with a fuel tank via a low-pressure line.

4. The pressure control valve in accordance with claim 1, further including an outlet port formed by said valve body and positioned opposite from said inlet port.

5. The pressure control valve in accordance with claim 4, wherein said outlet port is in direct fluid communication with an inlet port of a high-pressure pump.

6. The pressure control valve in accordance with claim 1, wherein said flow path extends axially from an input port to an output port.

7. The pressure control valve in accordance with claim 1, wherein said armature is positioned in said retention cup and wherein flow occurs in said flow path from said inlet port to said outlet port and from said outlet port to said inlet port.

8. The pressure control valve in accordance with claim 1, wherein said armature is positioned in said valve seat blocking flow through said flow path.

9. The pressure control valve in accordance with claim 1, further including an electrical connector, wherein a current sent via said electrical connector to said solenoid energizes said armature by creating a magnetic field.

10. The pressure control valve in accordance with claim 1, wherein said armature is a magnetic ball.

11. A pressure control valve for use with a high-pressure pump, comprising:
an inlet segment forming an inlet port;
an outlet segment forming an outlet port;
a center segment connecting said inlet segment with said outlet segment, wherein said inlet segment, said center segment, and said outlet segment form a valve body;
a flow path extending from said inlet port to said outlet port, wherein said flow path is formed by cylindrical center bores of said inlet segment, said center segment, and said outlet segment that are in fluid communication;
a spring received and guided by said inlet segment;
a magnetic ball attached to said spring; and
an electromagnet positioned around an outer circumference of said inlet segment;
wherein said electromagnet moves said magnetic ball from a first position to a second position, wherein said first position of said ball allows flow through said flow path, and wherein said second position of said ball blocks said flow path and stops said flow through said flow path.

12. The pressure control valve in accordance with claim 11, further including a valve seat integrated in said inlet segment and positioned opposite from said inlet port, wherein said valve seat receives said magnetic ball in said second position.

13. The pressure control valve in accordance with claim 12, wherein said valve seat is formed by a conically tapered lower end of said inlet segment, and wherein said valve seat has a size adapted to the diameter of said magnetic ball.

14. The pressure control valve in accordance with claim 11, further including a retention cup that retains said magnetic ball when said ball is in said first position.

15. The pressure control valve in accordance with claim 11, wherein said inlet segment includes a first section having a first diameter and a second section having a second diameter that is lager than said first diameter, wherein a shoulder is formed where said first section meets said second section, and wherein said shoulder retains said spring in axial direction.

16. The pressure control valve in accordance with claim 11, wherein said inlet segment includes connection features at an outer circumference, and wherein said connection features enable connection of said inlet segment to a low-pressure line.

17. The pressure control valve in accordance with claim 11, wherein said outlet segment has an outer circumference adapted to the size of an inlet port of said high-pressure pump, and wherein said outlet segment enables connection of said pressure control valve to said high-pressure pump.

18. A fuel system of a gasoline direct injection engine, comprising:
a fuel tank;
a pressure control valve in controlled fluid communication with said fuel tank via a low-pressure line, said pressure control valve including a centered axial flow path, an armature connected to a spring positioned in said flow path, said spring maintaining said armature in a first position, a solenoid moving said armature from said first position to a second position, wherein said first position allows flow of fuel through said flow path, and wherein said second position blocks said flow path and stops said flow of fuel through said flow path;
a high-pressure pump in direct fluid communication with said pressure control valve;
a fuel rail in fluid communication with said high-pressure pump via a high-pressure line; and
a plurality of fuel injectors in direct fluid communication with said fuel rail.

19. The fuel system of claim 18, further including an electrical connector, wherein an electronic signal via said electrical connector triggers said pressure control valve.

20. The fuel system of claim 18, wherein said pressure control valve further includes a valve body, wherein a shoulder is integrated in said valve body that retains axial position of said spring, wherein a valve seat is integrated in said valve body that receives said armature in said second position, and wherein a retention cup is positioned in said flow path that retains said armature in said first position.
